(19) United States
(12) Patent Application Publication
(10) Pub. No.: US 2011/0166917 A1
(43) Pub. Date: Jul. 7, 2011

(54) VIEWER CREDIT ACCOUNT FOR A MULTIMEDIA BROADCASTING SYSTEM

(75) Inventors: Dan Shang, Shanghai (CN); Qi Zhou, Shanghai (CN)

(73) Assignee: NXP B.V., Eindhoven (NL)

(21) Appl. No.: 12/995,872

(22) PCT Filed: Jun. 2, 2009
(86) PCT No.: PCT/IB09/52303

§ 371 Date: Mar. 18, 2011

(30) Foreign Application Priority Data
Jun. 2, 2008 (US) 61057937
Jun. 2, 2009 (IB) PCT/IB2009/052303

(51) Int. Cl. G06Q 30/00; H04N 7/10

(52) U.S. Cl. 705/14.7; 705/14.69; 725/32

(57) ABSTRACT

An ad token apparatus for managing a user credit account in a multimedia broadcasting system. The ad token apparatus includes a token embedder, a token cache, and a token verifier. The token embedder embeds a token in a digital advertisement stream to generate a token-embedded ad. The token includes an identifiable sequence of data of a predetermined length. The token cache stores the token and receives a detected token from the user device in response to detection of the token in the token-embedded ad by the user device. The token verifier adds at least one credit to a user credit account in response to receipt of the detected token. The user credit account corresponds to the user device.

Today, hundreds of television programs are transmitted to homes across the world. Some television programs are transmitted over the air via fixed broadcast networks, while others are transmitted via the internet, satellite and/or cable broadcast. In addition to traditional fixed broadcast television, mobile television networks are being developed around the world to transmit program broadcasts and event program streams to mobile devices such as cell-phones, personal digital assistants, mobile televisions, and so forth. Mobile television networks such as digital multimedia broadcasting (DMB) and digital video broadcast-handheld (DVB-H) allow users to receive television programs and event program streams virtually anywhere. However, DMB and DVB-H is similar to a fixed broadcast model in that the communications are one way, from the network to the user.

In comparison with the single-ended broadcast networks, multimedia broadcasting and multicast services (MBMS) offer two-way communications, from the network to the user, and from the user to the network. MBMS builds upon existing cellular infrastructure, such as the global system for mobile communications (GSM) and universal mobile telecommunications system (UMTS) networks. An MBMS network, embedded in an existing cellular network, offers the option to send data from a user to the network using an uplink channel. Providing uplink communications allows for interaction from the end user to the service provider, while typical mobile broadcasting networks only provide one-way communication from the service provider to the end user. Additionally, traditional multimedia services offered in the fixed broadcasting systems are also offered in the MBMS network.

Currently, the costs of most television programs and event program streams. These costs are typically subsidized by some form of advertising or paid for by subscriber fees, or some mixture of both. Subsidized programming appears free to the end user. Some satellite and cable television (CATV) operators offer additional channels for a subscriber fee in addition to running advertisements. Some networks offer advertisement-free programs and streams for a relatively higher subscription fee.

In the purely subsidized and mixed subsidized models, the user often sits through many advertisements for products they may have no interest in. For example, a young user 20-30 years old would typically not be interested in an advertisement for a product geared towards a 60-70 year old user, and vice versa. At the same time, an advertiser pays a substantial amount of money for an advertisement of their product to run during a television program. However, such an advertisement may go completely unwatched for various reasons, including the use of commercial skipping technology and viewer absence (e.g., the viewer stops watching to as grab a snack during a commercial break). Hence, under the current billing models for subsidized television programming, the end user does not have any say in the choice of advertising and a large part of the advertiser's money spent on advertisements is potentially wasted.

In the purely subscriber-fee based television programs such as pay-per-view events, no advertisements are shown in conjunction with an event program. However, the end user pays a considerably higher amount of money for the advertisement-free experience. The relatively higher costs of the purely subscriber-free based television programs are prohibitive for some viewers. At the same time, advertisers are blocked from introducing new products to the viewers because commercial breaks are omitted from the programming. As a result, television operators of purely subscriber-fee based television programs lose out on substantial advertising income from the advertisers, and the income from the end users is limited to those that can afford the higher cost of purely subscriber-fee based television programs.

The billing models of subsidized and subscriber-fee based television programming are rendered simplistic in relation to current and developing broadcasting technology. Under conventional billing models, the end users have no options besides ad-subsidized, subsidized-plus-subscription, and pure subscription programming. Additionally, the advertisements of advertisers are often not watched by the most interested users, and the TV operators have difficulties increasing their revenue because they are not able to simultaneously satisfy both the end user and the advertiser. Hence, the interests of the television operator, the advertiser, and the end user are not necessarily aligned to satisfy the interests of each party.

Embodiments of an apparatus are described. In one embodiment, the apparatus is an ad token apparatus for managing a user credit account in a multimedia broadcasting system. The ad token apparatus includes a token embedder, a token cache, and a token verifier. The token embedder embeds a token in a digital advertisement stream to generate a token-embedded ad. The token includes an identifiable sequence of data of a predetermined length. The token cache stores the token and receives a detected token from the user device in response to detection of the token in the token-embedded ad by the user device. The token verifier adds at least one credit to a user credit account in response to receipt of the detected token. The user credit account corresponds to the user device. Other embodiments of the apparatus are also described.

Embodiments of a method are also described. In one embodiment, the method is a method for managing a user credit account in a multimedia broadcasting system. One embodiment of the method includes embedding a token in a digital advertisement stream to generate a token-embedded ad. The token includes an identifiable sequence of data of a predetermined length. The method also includes sending the token-embedded ad to a user device for display on the user device. The method also includes receiving a detected token from the user device in response to detection of the token in the token-embedded ad by the user device. The method also includes adding at least one credit to a user credit account in response to receipt of the detected token. The user credit account corresponds to the user device.

Other aspects and advantages of embodiments of the present invention will become apparent from the following detailed description, taken in conjunction with the accompanying drawings, illustrated by way of example of the principles of the invention.

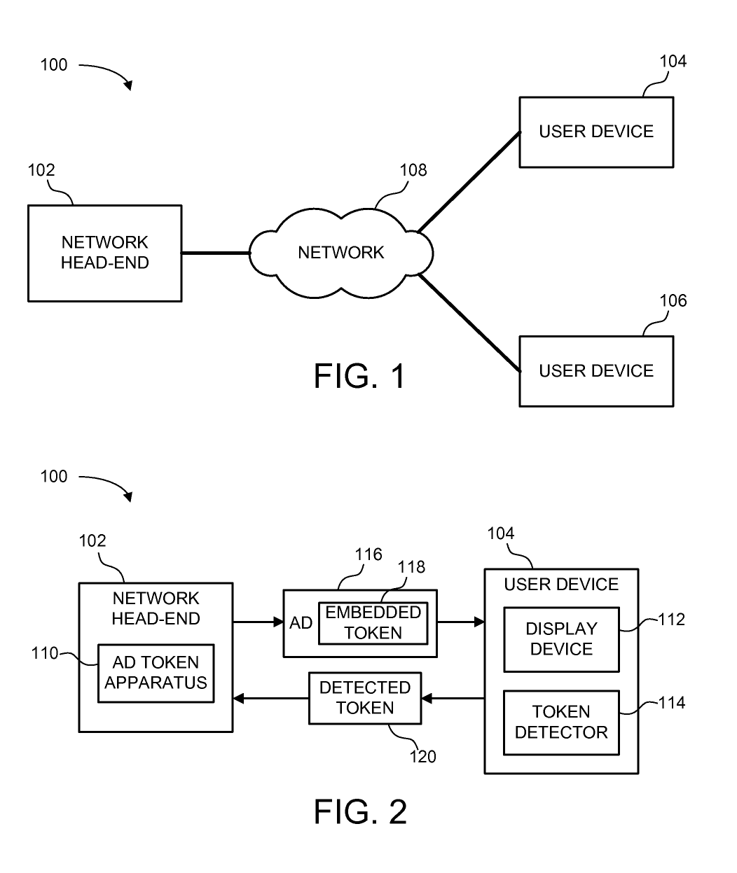

FIG. 1 depicts a schematic block diagram of one embodiment of a multimedia broadcast system.

FIG. 2 depicts a schematic block diagram of another embodiment of the multimedia broadcast system of FIG. 1.

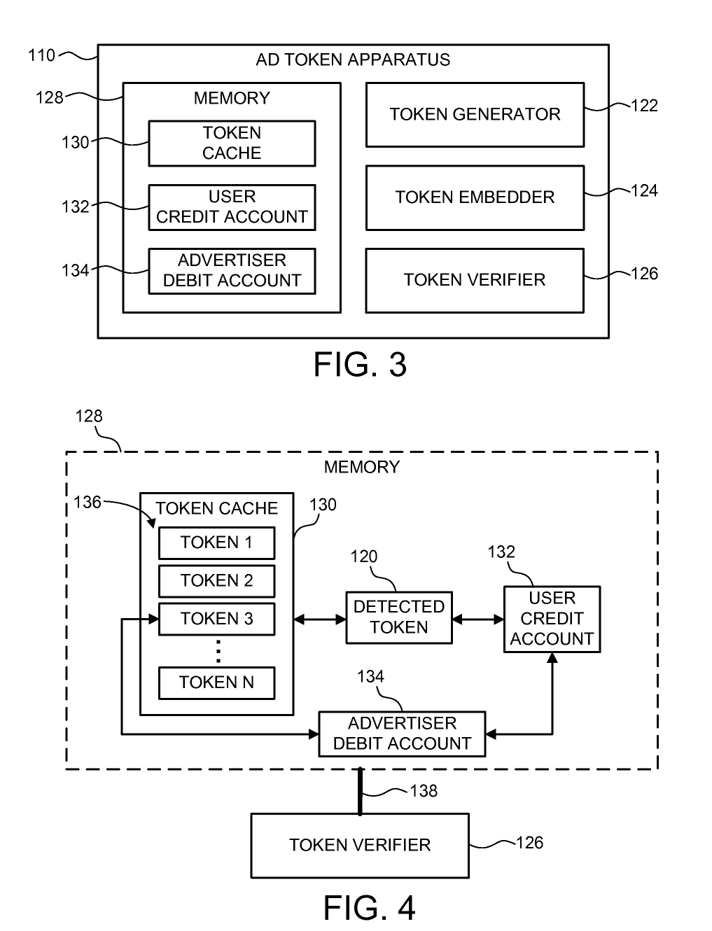

FIG. 3 depicts a schematic block diagram of one embodiment of an ad token apparatus for use with the multimedia broadcast system of FIG. 1.

FIG. 4 depicts a schematic block diagram of one embodiment of a memory architecture for the multimedia broadcast system of FIG. 1.

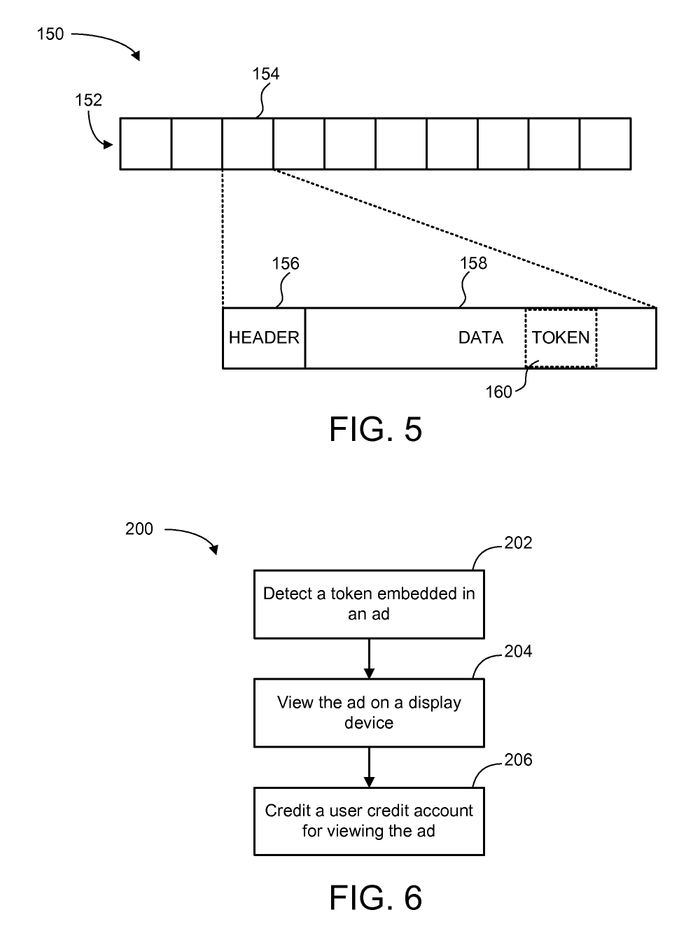

FIG. 5 depicts one embodiment of a token embedded in an ad stream structure.

FIG. 6 depicts a schematic flow chart diagram of one embodiment of a method for crediting a user account for watching a token-embedded ad.

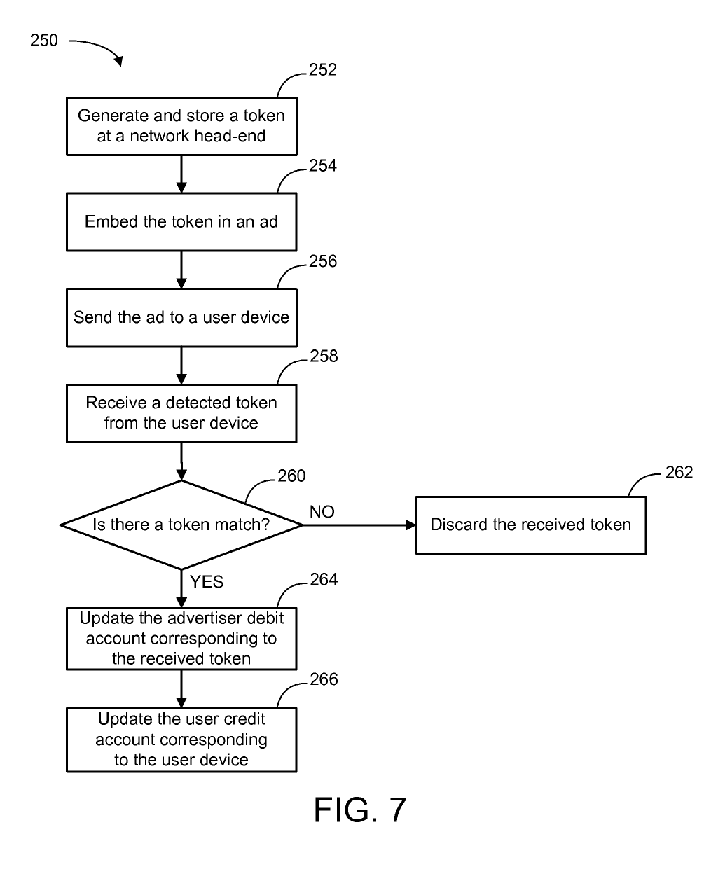

FIG. 7 depicts a schematic flow chart diagram of one embodiment of a method for managing tokens within the multimedia broadcast system of FIG. 1.

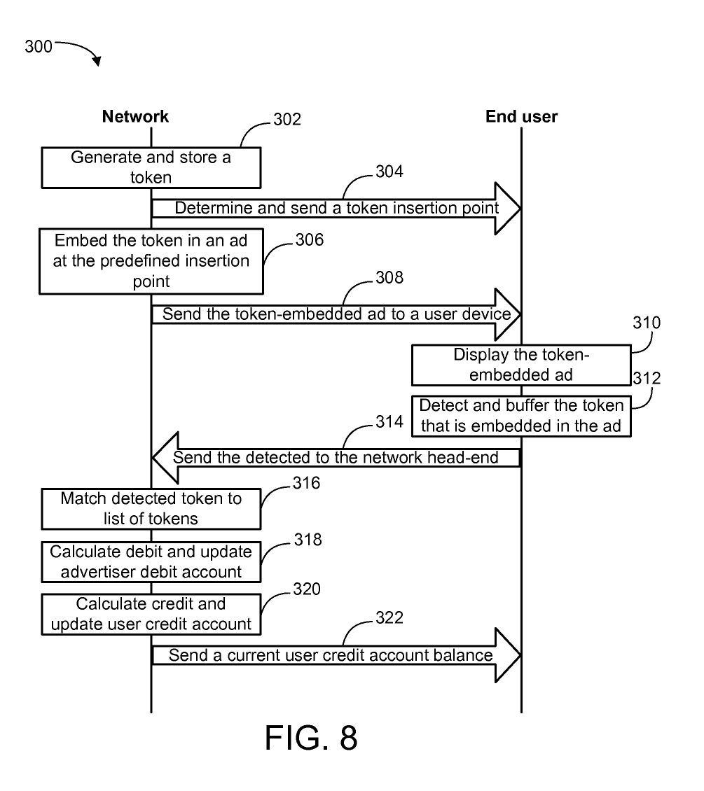

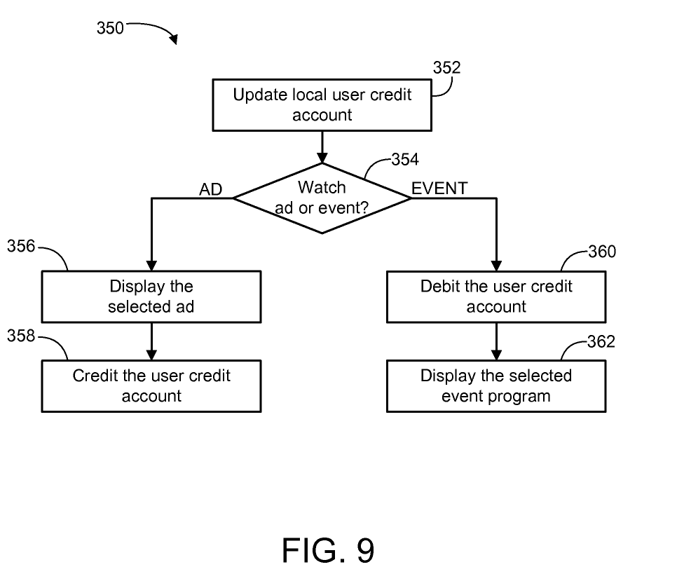

FIG. 8 depicts a schematic flow chart diagram of one embodiment of a process for managing accounts related to a token-embedded ad.

FIG. 9 depicts a schematic flow chart diagram of one embodiment of a method for redeeming credits for viewing an event program.

Throughout the description, similar reference numbers may be used to identify similar elements.

While many embodiments are described herein, at least some of the described embodiments facilitate management of a user credit account in a multimedia broadcasting system. In one embodiment, a user is enabled to selectively choose what type of ads he or she is most interested in watching. In some embodiments, the ads include digital streaming ads. The user may select individual ads to watch from a list of ads. The list of ads may be sorted by types of ads, by target age groups, by product lines, etc. In some embodiments, an identifiable sequence of data, or token, is generated separate from an ad and embedded in an ad selected for viewing by the user. In some embodiments, an association between the token and an advertiser is stored on a memory device. The user watches the ad on a viewing device, or user device. The user implements the user device to watch event programs as well. When the user watches the ad, the token embedded in the ad is detected by the user device. The token may also be buffered and verified. Likewise, in some embodiments, an association between a detected token and a user is determined and stored on a memory device. In one embodiment, the token is sent to a network head-end for verification, indicating that the selected ad was viewed by the user. With this information, the network head-end tracks how many advertisements the user watches and charges advertisers accordingly. Moreover, the network head-end also rewards the user with credits that the user may redeem for selecting and viewing event programs in exchange for a predetermined amount of credits. As a result, the end user uses the rewarded credits to pay for their favorite programs, and the advertiser's ads target the people who are potentially most interested in the advertised products.

FIG. 1 depicts a schematic block diagram of one embodiment of a multimedia broadcast system 100. The illustrated multimedia broadcast system 100 includes a network head-end 102, a plurality of user devices 104 and 106, and a network 108. It should be noted that the configurations of the network head-end 102, the user devices 104 and 106, and the network 106 are not limited to particular hardware or software implementations. Although the depicted multimedia broadcast system 100 is shown and described herein with certain components and functionality, other embodiments of the multimedia broadcast system 100 may be implemented with fewer or more components or with more or less functionality. For example, some embodiments of the multimedia broadcast system 100 include a plurality of network head-ends 102 and/or networks 106. Additionally, some embodiments of the multimedia broadcast system 100 include similar components arranged in another manner to provide similar functionality, in one or more aspects.

Additionally, where two or more user devices such as the user devices 104 and 106 are present within the multimedia broadcast system 100, in one embodiment, the network head-end 102 may facilitate a single event program among the user devices 104 and 106. Alternatively, in some embodiments, multiple user devices may be present within the multimedia broadcast system 100 and the network head-end 102 may facilitate a unique event program to each user device such as with a video on demand (VOD) or switched digital video (SDV) service.

In one embodiment, the network head-end 102 is a master facility for generating television signals for distribution over the network 106. The network head-end 102 may include head-end equipment, including the network 106, to receive and re-transmit video over a local infrastructure. In some embodiments, the network head-end 102 includes a coaxial network and network hubs to implement a cable television head-end facility. In some embodiments, the network head-end 102 includes a satellite feed, an orbiting satellite, and satellite dishes to implement a satellite television head-end facility. In some embodiments, the network head-end 102 includes switches, routers, and local network hubs to implement an internet protocol television (IPTV) head-end facility.

The user devices 104 and 106 are referred to, in some instances, as set-top boxes. A set-top box receives an input video signal and processes the input video signal for display on a display device. In some embodiments, the user devices 104 and 106 include a set-top box in a home viewing environment such as a cable modem set-top box or a satellite receiver set-top box. Alternatively, in some embodiments the user devices 104 and 106 include a mobile media device capable of receiving an event program beamed over the air such as from a satellite or a fixed data tower. One example of a mobile media device includes a cell-phone. Other similar mobile media devices may also be implemented.

In one embodiment, the network 106 includes a television network. In some embodiments, the network 106 includes switched networks such as an intranet, the internet, a local area network (LAN), a wide area network (WAN), and so forth. Additionally, the network 106 includes data networks such as cellular networks, UMTS, and GSM. The network 106 includes, in some embodiments, coaxial and/or fiber-optic lines between the network head-end 102, a local television station, and/or the user devices 104 and 106. In some embodiments, the network 106 includes satellite receivers to receive a satellite-beamed video signal originated at the network head-end 102.

FIG. 2 depicts a schematic block diagram of another embodiment of the multimedia broadcast system 100 of FIG. 1. Although the depicted multimedia broadcast system 100 is shown and described herein with certain components and functionality, other embodiments of the multimedia broadcast system 100 may be implemented with fewer or more components or with more or less functionality. Additionally, some embodiments of the multimedia broadcast system 100 include similar components arranged in another manner to provide similar functionality, in one or more aspects.

The illustrated network head-end 102 includes an ad token apparatus 110. Additionally, the user device 104 includes a display device 112 and a token detector 114. The illustrated user device 104 of FIG. 2 is representative of the plurality of user devices 104 and 106 of FIG. 1. Other user devices may be implemented with fewer or more components or with more or less functionality than the illustrated user device 104 of FIG. 2.

Additionally, the multimedia broadcast system 100 of FIG. 2 depicts an ad 116 with an embedded token 118, and a detected token 120. As illustrated, the ad token apparatus 110 inserts the embedded token 118 in the ad 116. The ad token apparatus 110 then sends the ad 116 to the user device 104. The display device 112, in one embodiment, displays the ad 116 to a user. Thus, the user is enabled to watch the token-embedded ad 116 on the display device 112. The token detector 114, in one embodiment, detects the embedded token 118 in the ad 116. In some embodiments, the token detector 114 sends the detected token 120 back to the network head-end 102. More specifically, in some embodiments, the token detector 114 sends the detected token 120 back to the network head-end 102 for verification of the detected token 120 at the network head-end 102. In some embodiments, the ad token apparatus 110 receives a detected token 120 from the user device 104 in response to a detection of the embedded token 118 in the ad 116 by the token detector 114

In some embodiments, the token detector 114 sends two or more detected tokens back to the network head-end 102. In one embodiment, the token detector 114 waits to send the detected token 120 back to the network head-end 102 during an uplink operation. Alternatively, in some embodiments, the token detector 114 immediately sends the detected token 120 back to the network head-end 102 following detection of the embedded token 118 in the ad 116. One example of the ad token apparatus 110 is shown in FIG. 3 and described in more detail below.

FIG. 3 depicts a schematic block diagram of one embodiment of an ad token apparatus 110 for use with the multimedia broadcast system 100 of FIG. 1. As depicted, the ad token apparatus 110 includes a token generator 122, a token embedder 124, a token verifier 126, and a memory device 128. Additionally, the memory device 128 includes a token cache 130, a user credit account 132, and an advertiser debit account 134. Although the depicted ad token apparatus 110 is shown and described herein with certain components and functionality, other embodiments of the ad token apparatus 110 may be implemented with fewer or more components or with less or more functionality. In some embodiments, the components of the ad token apparatus 110 are at least partially integrated on one or more ICs.

The illustrated ad token apparatus 110 enables a network head-end 102 to reward an end user for watching an advertisement. Additionally, by associating a token with an ad, the illustrated ad token apparatus 110 enables a network head-end 102 to track a quantity and types of ads viewed in association with a certain event program such as a television show, movie, or sports related program. In one embodiment, the token generator 122 generates the token apart from an ad. The token includes an identifiable sequence of data of a predetermined length. In some embodiments, the token generator 122 generates the token from a sequence of data contained in an event program. For example, in a digital streaming event program, the token generator 122 may randomly select a sequence of bits from a packet of the digital streaming event program. The token generator 122 may then generate the token directly from the selected sequence of bits or from a processed form of the selected sequence of bits. In some embodiments, the token generator is configured to randomly generate the token as a random sequence of data.

The token embedder 124, in one embodiment, embeds the token in the ad. In some embodiments, the token embedder 124 sends the token-embedded ad to a user device such as the illustrated user device 104 of FIG. 2. In some embodiments, the token embedder 124 is configured to embed the token at a predefined location of the ad. For example, the token embedder 124 may embed the token in the header of a digital streaming ad such as a Moving Pictures Expert Group (MPEG) encoded ad. In some embodiments, the token embedder 124 is configured to send the predefined location where the token is embedded in the ad to the user device 104 so that the user device 104 knows where to find the token in the ad. In some embodiments, the token generator 122 appends a token indicator at the beginning of a generated token. The token indicator identifies the presence of a token in an ad to the user device 104.

In one embodiment, the token verifier 126 adds at least one credit to a user credit account 132 in response to a receipt of the detected token. The user credit account 132 corresponds to the user device 102. Some embodiments of the functions and operation of the token verifier 126 are described with reference to FIG. 4.

FIG. 4 depicts a schematic block diagram of one embodiment of a memory architecture of the multimedia broadcast system 100 of FIG. 1. The memory architecture of FIG. 4 is depicted in relation to the memory device 128 of FIG. 3. Although the depicted memory architecture of FIG. 4 is shown and described herein with certain components and functionality, other embodiments of the depicted memory architecture may be implemented with fewer or more components or with less or more functionality.

The implementation of the multimedia broadcast system 100 of FIG. 1 depicted in FIG. 4 includes the memory device 128 and the token verifier 126. The memory device 128 includes the detected token 120, the token cache 130, the user credit account 132, and the advertiser debit account 134. The token cache 130 includes a list of tokens 136.

In one embodiment, the token verifier 126 verifies the token embedded in the ad by comparison. The detected token 120 is compared to a list of tokens 136 stored in the token cache 130 to identify the originally generated token stored in the token cache 130 as a match for the detected token 120. Additionally, in some embodiments, the token verifier 126 identifies an advertiser associated with the detected token 120. In other words, if the token embedder 124 embeds a token in an ad from company XYZ, in some embodiments, an association between the token and the advertiser is stored in the memory device 128, associating company XYZ with a specific token. In some embodiments, an advertiser identification (ID) is contained in the token. Hence, in some embodiments, the token verifier 126 determines the association between the token and an associated advertiser by reading an advertiser ID field in the detected token 120. In response to matching the detected token 120 with one of the tokens from the list of tokens 136 stored in the token cache 130, the token verifier 126 then debits an advertiser debit account 134 accordingly.

Additionally, in some embodiments, the token verifier 126 identifies a user associated with the detected token 120. In other words, if the token embedder 124 sends a token in an ad to a user XYZ of the user device 104, in some embodiments, an association between the token and the user is stored in the memory device 128, associating user XYZ with a specific token. In some embodiments, a user identification (ID) is contained in the token. Hence, in some embodiments, the token verifier 126 determines the association between the token and an associated user by reading a user ID field in the detected token 120. In one embodiment, the token verifier 126 debits the advertiser debit account 134 based on an ad parameter. The ad parameter includes an ad fee and a split factor. In some embodiments, the token verifier 126 adds at least one credit to the user credit account 132 relative to a portion of the ad fee based on the split factor. The split factor includes a percentage of the ad fee. The ad fee is the price that the network head-end 102 charges an advertiser for running an advertisement of the advertiser. The split factor is a predetermined ratio of the ad fee that the network head-end 102 determines. The network head-end 102 uses the split factor to determine how much of the ad fee to give to the end user for watching an advertisement. The value of the split factor may be based on the length of the advertisement, the number of times an advertisement has previously been viewed, and so forth. For example, the split factor for a certain ad may be preset by the network head-end 102 to 25%. Thus, if the network head-end 102 charges the advertiser $1.00 for a single viewing of a particular ad, then the network head-end 102 debits the advertiser debit account 134 by $1.00 and gives a portion of the $1.00 to the end user based on the split factor, or in this case, 25% of $1.00, or 25 cents.

In one embodiment, the illustrated memory device 128 stores the generated token in the token cache 130. In some embodiments, the token cache includes a list of tokens 136, as described above in relation to FIG. 4. In some embodiments, the memory device 128 stores an account balance of the user credit account 132. In some embodiments, a user is enabled to redeem the credits stored in the user's user credit account 132 for viewing a selected event program. In some embodiments, the memory device 128 sends the current account balance of the user's user credit account 132 to the user device 104. Hence, a user is enabled to view a current balance of the user credit account 132. In some embodiments, the memory device 128 is configured to store an account balance of an advertiser debit account 134. As described above, an advertiser is charged directly for each individual viewing of a particular ad. In some embodiments, the memory device 128 sends the current account balance of an advertiser's advertiser debit account 134 to the advertiser. Hence, an advertiser is enabled to view at least an approximation of the exact quantity of ads viewed for a given time period, the amount that the advertiser was charged by the network head-end 102 for the viewing of each ad, and so forth.

FIG. 5 depicts one embodiment of a token 160 embedded in an ad stream structure 150. As described above, in some embodiments, the ad token apparatus 110 generates a token 160 and embeds the token 160 in an ad. The ad stream structure 150 includes an ad stream 152 and a packet 154 from the ad stream 152. Additionally, the ad stream structure 150 includes a header 156 and a data segment 158 of the packet 154. As illustrated, the data segment 158 includes the inserted token 160. More specifically, the ad stream structure 150 depicts the token 160 embedded in a stream 152 of an ad. As illustrated, the ad is in a digital streaming version of an ad. Some embodiments include other versions of an ad such as an analog version and/or a downloadable version.

As depicted, the ad stream 152 includes a plurality of packets similar to an MPEG transport stream. Although the ad stream structure 150 of FIG. 5 depicts the insertion of a single token at a certain point of the ad stream 152, in some embodiments, the token embedder 124 inserts several tokens at one or more points of the ad stream 152. In one embodiment, the token embedder 124 embeds the token 160 at a predetermined location of the ad stream 152. Although the token 160 is depicted as being embedded in the data segment 158 of the packet 154, in some embodiments, the token embedder 124 inserts the token in the header 156 of the packet 154. In some embodiments, the header 156 includes a token field. In other words, in some embodiments, the header 156 includes a field of a certain length that is specifically implemented to include the token 160. Alternatively, as described above, some embodiments of the token embedder 124 notify the user device 124 of the predetermined location of the token 160 in the ad stream 152. Hence, the token detector 114 is aware of the location of the token 160 in the ad stream 152.

FIG. 6 depicts a schematic flow chart diagram of one embodiment of a method 200 for crediting a user account for watching a token-embedded ad. Although the crediting method 200 is described in conjunction with the multimedia broadcast system 100 of FIG. 1 and components thereof, other embodiments of the crediting method 200 may be implemented with other multimedia broadcasting systems and/or other components thereof. In one embodiment, the network head-end 102 embeds the token in an ad and sends the token-embedded ad to the user device 104. In some embodiments, at block 202, the token detector 114 detects the token embedded in the ad. At block 204, the display device 112 displays the ad to allow a user to view the token-embedded ad. In some embodiments, the user device 104 sends the detected token 120 back to the network head-end 102. More specifically, the user device 104 sends the detected token 120 to the network head-end 102 for verification at the network head-end 102.

As described above, in some embodiments, the token verifier 126 compares the detected token 120 to a list of tokens 136 in order to match the detected token 120 to a user and/or the user credit account 132. At block 206, the token verifier 126 credits the user credit account 134 based on a positive verification of the detected token 120. The positive verification of the detected token 120 indicates that the display device 112 displays the ad.

FIG. 7 depicts a schematic flow chart diagram of one embodiment of a method 250 for managing tokens with the multimedia broadcast system 100 of FIG. 1. Although the method 250 is described in conjunction with the multimedia broadcast system 100 of FIG. 1 and components thereof, other embodiments of the method 250 may be implemented with other multimedia broadcasting systems and/or other components thereof.

At block 252, in one embodiment, the token generator 122 generates a token at the network head-end 102. In some embodiments, the token generator 122 generates a random sequence of data separate from data associated with or contained in the ad. In some embodiments, the token generator 122 generates the token from a sequence of data taken from an event program. For example, the token generator 122 may copy a predetermined length of bits contained in a packet of a digitized streaming event program. The token generator 122 may then generate the token directly from the copied bits of the digitized streaming event program. Alternatively, and some embodiments the token generator 122 may generate the token from a processed version of the copied bits of the digitized streaming event program such as an XOR of the copied bits.

In one embodiment, at block 254, the token embedder 124 embeds the generated token in an ad. Additionally, the token embedder 124 may embed the generated token at a predetermined location of the ad. As described above, in some embodiments, the token embedder 124 embeds the token in a data segment 158 of a digital streaming ad. Likewise, the token embedder 124 may embed the token in a header 156 of a digital streaming ad.

At block 256, in some embodiments, the ad token apparatus 110 sends the token-embedded ad to the user device 104. Additionally, the ad token apparatus 110 sends the user device 104 the predetermined location where the token embedder 124 embeds the token in the ad. In some embodiments, the token detector 114 detects the token in the ad based on the predetermined location signal received from the network head-end 102. Alternatively, in some embodiments, the token detector 114 detects the token in the ad based on a token indicator at the beginning of the token. In some embodiments, the token indicator may include a predetermined length of binary zeros. In response to the display of the token-embedded ad on the display device 112, the user device 104 sends the detected token 120 back to the network head end 102. In some embodiments, at block 258 the network head end 102 receives the detected token 120 from the user device 104.

At block 260, in one embodiment, the token verifier 126 determines whether the detected token 120 matches a token stored in the token cache 130. More specifically, the token verifier 126 compares the detected token 120 to a list of tokens 136 stored in the token cache 130. If the token verifier 126 determines that no match exists for the detected token 120, then the token verifier 126 discards the detected token 120 at block 262.

Otherwise, at block 264, the token verifier 126 updates the advertiser debit account 134 associated with the detected token 120. The advertiser debit account 134 is matched to the detected token 120 according to a successful match of a token in the list of tokens 136 to the detected token 120. In other words, a token stored in the token list 136 may include an association between an advertiser, an advertiser debit account 134, a user, a user credit account 132, and at least one ad. As described above, in some embodiments, the token verifier 126 compares the detected token 120 to a list of tokens 136 in order to match the detected token to a user and an advertiser associated to the detected token. At block 266, in one embodiment, the token verifier 126 updates the user credit account 132 corresponding to the user device 102.

FIG. 8 depicts a schematic flow chart diagram of one embodiment of a process 300 for managing accounts related to a token-embedded ad. Although the process 300 is described in conjunction with the multimedia broadcast system 100 of FIG. 1 and components thereof, other embodiments of the process 300 may be implemented with other multimedia broadcasting systems and/or other components thereof.

At block 302, in one embodiment, the network head-end 102 generates a token and stores the token in the token cache 130. In some embodiments, at block 304, the token embedder 124 determines an insertion point of an ad where the token is embedded in the ad. The ad token apparatus 110 then sends the insertion point to the user device 104. At block 302, in some embodiments, the token embedder 124 embeds the token in the ad. More specifically, the token embedder 124 may embed the token in the ad at the predefined insertion point. At block 308, the ad token apparatus 110 sends the token-embedded ad to the user device 104.

In one embodiment, at block 310, the user device 104 displays the token embedded ad on the display device 112. At block 312, the token detector 114 detects the token in the ad and buffers the token in a local buffer (not shown). At block 314, in some embodiments, the token detector 114 sends the detected token back to the network head-end 104. As described above, in one embodiment, the ad token apparatus 110 receives the detected token and the token verifier 126 then compares the detected token 120 to a list of tokens 136 stored in the token cache 130.

At block 316, the token verifier 126 matches the detected token 120 to a token contained in the list of tokens 136. In some embodiments, at block 318, the token verifier 126 calculates a debit based on an ad parameter associated with the detected token 120. The ad parameter includes a predetermined ad fee, a split factor, an ad length, event program data associated with the token-embedded ad, and so forth. Based on the calculated debit, the token verifier 126 updates the advertiser debit account 134. Likewise, at block 320, the token verifier 126 calculates a credit based on the ad parameter and updates the user credit account 132 based on the calculated credit. In other words, the token verifier 126 identifies a user and an advertiser associated with the detected token 120. The token verifier 126 then debits the advertiser debit account 134 associated with the identified advertiser based on the ad fee. Additionally, the token verifier 126 adds at least one credit to the user credit account 132 based on a portion of the ad fee associated with the detected token 120. In some embodiments, the portion of the ad fee is based on the split factor. As described above, in some embodiments, the split factor is a percentage of the ad fee such as 20% of the ad fee.

In one embodiment, at block 322, the ad token apparatus 110 sends a current balance of the user credit account 132 to the user device 104. In some embodiments, the ad token apparatus 110 sends the current balance of the user credit account 132 based on a current balance request by the user device 104. FIG. 9 depicts a schematic flow chart diagram of one embodiment of a method 350 for redeeming credits for viewing an event program. Although the method 350 is described in conjunction with the multimedia broadcast system 100 of FIG. 1 and components thereof, other embodiments of the method 350 may be implemented with other multimedia broadcasting systems and/or other components thereof. At block 352, the user device 104 updates a local user credit account stored locally on a memory device (not shown) of the user device 104.

In one embodiment, at block 354, a user of the user device 104 determines whether to watch an ad or an event program. In some embodiments, the display device 112 displays a list of ads and or event programs that allows the user to select from a variety of ads and/or event programs. For example, the display device 112 may display a list of ads by product type, price, and so forth. Additionally, the display device 112 may display a list of event programs by title, price, and so forth. If the user selects to view an ad, then at block 356 the display device 112 displays a token-embedded ad. For watching the ad, at block 358 the user may be credited in his or her user credit account 132.

Otherwise, at block 360, if the user selects to display an event, then the user's user credit account 132 is charged for the price of the event program selected by the user. If the user credit account 132 contains enough credits from previously viewed token-embedded ads to pay for the price of the selected event program, then the user may pay for the selected event program solely by the credits. Alternatively, the credits in the user credit account 132 may be used to obtain a discount, so that the selected event program may be paid for using a combination of credits and monetary payment. At block 362, the display device 112 displays the selected event program.

It should be noted that at least some of the operations for the methods 200 and 250 and the processes 300 and 350 may be implemented using software instructions stored on a computer useable storage medium for execution by a computer. As an example, an embodiment of a computer program product includes a computer useable storage medium to store a computer readable program that, when executed on a computer, causes the computer to perform operations. In one embodiment, the operations include an operation to embed a token in a digital advertisement stream to generate a token-embedded ad. The token includes an identifiable sequence of data of a predetermined length. Additionally, the operations include operations to send the token-embedded ad to a user device for display on the user device, to receive a detected token from the user device in response to detection of the token in the token-embedded ad by the user device, and to add at least one credit to a user credit account in response to a receipt of the detected token. The user credit account corresponds to the user device.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations comprising:
embed a token in a digital advertisement stream to generate a token-embedded ad, wherein the token comprises an identifiable sequence of data of a predetermined length;
send the token-embedded ad to a user device for display on the user device;
receive a detected token from the user device in response to detection of the token in the token-embedded ad by the user device; and
add at least one credit to a user credit account in response to receipt of the detected token, wherein the user credit account corresponds to the user device.

2. The computer program product of claim 1, wherein the computer readable program, when executed on the computer, causes the computer to perform operations comprising:
identify an advertiser associated with the detected token; and
debit a debit amount from an advertiser debit account in response to the receipt of the detected token, wherein the advertiser debit account corresponds to the detected token and the advertiser.

3. The computer program product of claim 2, wherein the computer readable program, when executed on the computer, causes the computer to perform operations to calculate the at least one credit based on the debit amount and an ad parameter, wherein the ad parameter comprises an ad fee and a split factor, wherein the split factor indicates a portion of the ad fee to be allocated to the user credit account.

4. The computer program product of claim 1, wherein the computer readable program, when executed on the computer, causes the computer to perform operations to debit a redemption amount from the user credit account, wherein the redemption amount corresponds to a selected event program.

5. The computer program product of claim 1, wherein the computer readable program, when executed on the computer, causes the computer to perform operations to randomly generate the token as a random sequence of data.

6. The computer program product of claim 1, wherein the computer readable program, when executed on the computer, causes the computer to perform operations to embed the token at a predefined location of the digital advertisement stream.

7. The computer program product of claim 6, wherein the computer readable program, when executed on the computer, causes the computer to send the predefined location where the token is embedded in the ad to the user device.

8. The computer program product of claim 1, wherein the computer readable program, when executed on the computer, causes the computer to perform further operations comprising:
store the token in a token cache with a plurality of additional tokens corresponding to a plurality of additional digital advertisement streams; and
compare the detected token with the token in the token cache to identify the token as a match for the detected token.

9. A method for managing a user credit account in a multimedia broadcasting system, the method comprising:
embedding a token in a digital advertisement stream to generate a token-embedded ad, wherein the token comprises an identifiable sequence of data of a predetermined length;
sending the token-embedded ad to a user device for display on the user device;
receiving a detected token from the user device in response to detection of the token in the token-embedded ad by the user device; and
adding at least one credit to a user credit account in response to receipt of the detected token, wherein the user credit account corresponds to the user device.

10. The method of claim 9, further comprising:
identifying an advertiser associated with the detected token; and
debiting a debit amount from an advertiser debit account in response to the receipt of the detected token, wherein the advertiser debit account corresponds to the detected token and the advertiser.

11. The method of claim 10, further comprising calculating the at least one credit based on the debit amount and an ad parameter, wherein the ad parameter comprises an ad fee and a split factor, wherein the split factor indicates a portion of the ad fee to be allocated to the user credit account.

12. The method of claim 9, further comprising debiting a redemption amount from the user credit account, wherein the redemption amount corresponds to a selected event program.

13. The method of claim 9, further comprising randomly generating the token as a random sequence of data.

14. The method of claim 9, further comprising embedding the token at a predefined location of the digital advertisement stream.

15. The method of claim 14, further comprising sending the predefined location where the token is embedded in the ad to the user device.

16. The method of claim 9, further comprising:
storing the token in a token cache with a plurality of additional tokens corresponding to a plurality of additional digital advertisement streams; and
comparing the detected token with the token in the token cache to identify the token as a match for the detected token.

17. An ad token apparatus, the ad token apparatus comprising:
a token embedder to embed a token in a digital advertisement stream to generate a token-embedded ad, wherein the token comprises an identifiable sequence of data of a predetermined length;
a token cache coupled to a memory device, the token cache to store the token and to receive a detected token from the user device in response to detection of the token in the token-embedded ad by the user device; and
a token verifier coupled to the token cache, the token verifier to add at least one credit to a user credit account in response to receipt of the detected token, wherein the user credit account corresponds to the user device.

18. The apparatus of claim 17, wherein the token verifier is further configured to identify an advertiser associated with the detected token and to debit a debit amount from an advertiser debit account in response to the receipt of the detected token, wherein the advertiser debit account corresponds to the detected token and the advertiser.

19. The apparatus of claim 17, wherein the token verifier is further configured to calculate the at least one credit based on the debit amount and an ad parameter, wherein the ad parameter comprises an ad fee and a split factor, wherein the split factor indicates a portion of the ad fee to be allocated to the user credit account.

20. The apparatus of claim 12, further comprising a token generator coupled to the token embedder, the token generator to generate a token apart from an ad, wherein the token comprises an identifiable sequence of data of a predetermined length.
